(19) United States
(12) Patent Application Publication
(10) Pub. No.: US 2003/0115802 A1
(43) Pub. Date: Jun. 26, 2003

(54) Device for opening and closing a moveable part with a seal having a hollow section

(76) Inventors: Achim Neubauer, Sinzheim-Vormberg (DE); Jochen Moench, Sinzheim (DE); Hartmut Krueger, Buehlertal (DE)

Correspondence Address: STRIKER, STRIKER & STENBY, 103 East Neck Road, Huntington, NY, 11743, US

(21) Appl. No.: 10/282,375

(22) Filed: Oct. 29, 2002

(30) Foreign Application Priority Data
Dec. 21, 2001 (DE) 101 63 063.8

(51) Int. Cl. E05F 15/02

(52) U.S. Cl. 49/28

(57) ABSTRACT

A device for opening and closing a motor-driven part (10) on a motor vehicle includes a seal (28) arranged along a frame (14) of the part (10), a control unit (30), and clamping protection device. The clamping protection device recognizes an objected in the displacement path of the part (10) upon closing of the part (10) and relays a signal to the control unit (30) in order to stop or reverse the movement of the part (10). The seal (28) has at least one closed hollow section (16) with a defined cross-section (18), which is filled with a liquid or gas medium (34). The hollow section (16) is provided with a measuring device (30), with which at least one measured parameter of the medium (34) is measurable in dependence on a change of the cross-section (18).

### BACKGROUND OF THE INVENTION

The present invention relates to a device for opening and closing a moveable part.

DE 199 13 106 C1 discloses a clamping protection device with a hollow section for a force-operated closing device, in which the connecting strip is disposed along a frame, for example, a sliding roof opening. The hollow section has two spaced and electrically conductive areas, whose contact starts a switching operation for controlling the motor of the closing device. Therefore, the manufacture of such a switching strip is expensive, and in use, such a system results in incorrect actuation, which, in particular, is caused by the lasting deformation or wear of the electrically conductive areas.

### SUMMARY OF THE INVENTION

The device of the present invention has the advantage that such a hollow section can be very simply manufactured and is filled with a liquid or gas medium. Therefore, the clamping protection device has no moveable components and is only susceptible to wear and aging in a minimal amount. The hollow section can be deformed with minimal force, so that its cross-section is significantly changed. For starting of the clamping protection, measured parameters of the medium can be valued, which directly depend on the deformation of the hollow section. Therefore, a quantitative amount for the force on the sealing exists, with which provided spring installments of the clamping protection function can be restrained. Since also no electrical contacts within the hollow section are necessary, system related problems of the electrical switching strip are prevented and in addition, the most cost effective and wear-resistance clamping protection is realized.

It is particularly preferred if the hollow section has a substantially circular cross-section without outer force effects. Therefore, the cross-section of the hollow section in each case is reduced, as soon as a radial force acts on the hollow section. In this manner, also clamping forces, which act outside of the sliding plane of the hollow section, can be detected.

It is very cost effective if the hollow section is made as a hollow chamber in the interior of the seal. An extrusion method is particularly advantageous, in which the hollow section is made in one process with the seal without additional expenditure. The wall of the hollow section represents simultaneously a part of the seal section and optimally can be adapted to the movability of the hollow chamber wall that is required for the clamping protection.

In an alternative embodiment, the hollow section can be separately made as a hose-shaped little tube, which can be arranged subsequently in the interior or on the surface along the sealing section. This has the advantages that other materials can be used for both the hollow section as well as the sealing section, and the hollow section also can be fused or adhered, for example, also subsequently along the seal.

In order to ensure the strength of the material of the hollow section compared with the medium located therein also over a long time-frame, the hollow section can be coated with a special inner coating, which, for example, can be made with a solution integrated in the sealing section, also by means of a two-phase extrusion process.

If the hollow section has a thin wall, particularly in the area in which the expected clamping force is to engage, the hollow section is slightly deformably in the radial direction. In this manner, the cross-section of the hollow section is reliably reduced upon a clamping event and is detected with the measuring device.

Therefore, the hollow section, upon the action of a clamping force, does not move and the obstacle can be avoided. The hollow section braces on the frame on the side facing away from the moveable part. Thereby, it is important that no elastically deformable material is located between the frame and the hollow section, with which the hollow section, upon occurrence of an obstacle, is pressed together and immediately operates the clamping protection device.

If the hollow section is filled with a generally incompressible liquid, a deformation of the hollow section can be detected very quickly and reliably via a pressure change of the medium in the hollow section.

In a further embodiment, the hollow section is filed with a conductive medium, for example, a saline solution, whereby a cross-sectional change of the hollow section by means of a conductivity measurement can be identified. With the use of a saline solution, no additional requirements compared with typical sealing materials are imposed on the materials of the hollow section, since the seal in the area of the sealing lips, in any case, is constantly exposed in winter road traffic to a salt solution. A saline solution can also be used in minus-temperatures without problems and creates no problem, in the event a leak of the hollow section should occur.

The use of a medium with a high viscosity has the advantage of avoiding an escape of the medium upon the occurrence of a leak in the hollow section.

If the pressure of the medium within the closed hollow section is used as a measured parameter, the pressure can be measured in a simple manner by means of a pressure sensor disposed on the end of the hollow section. Through the arrangement of the pressure sensor on the lower end of the hollow section, a disruption of the pressure measuring by an eventually occurring air gust can be prevented. For the measuring of fast acting pressure changes, a pressure sensor with a piezzo element as a pressure converter is suitable. By means of a pressure change, deformation of the hollow section at specific points and also along the longitudinal direction of the hollow section can be registered in an advantageous manner.

A further possibility for detecting a cross-sectional change of the hollow section is the measurement of conductivity of the medium over the entire length of the hollow section. In this manner, the conductivity is measured, for example, by means of a transistor actuator, which can be a component of the control apparatus.

Particularly advantageous is the measurement of the temporal change of the measured parameter for the detection of a clamping event, since slow changes of the measured parameters by external effects, such as temperature, aging, sun rays or outer magnetic fields can be eliminated. In this manner, short-lived changes of the measured parameters for the clamping protection function can be valued, which can be compared with a previously determined threshold value of the temporal measured parameter change, and upon exceeding or falling below the threshold value, the part is stopped or reversed. In this manner, false starting by long-term changes and external effects are effectively avoided.

If the actual value of at least one measured parameter is continually measured and compared with a saved ideal value of the measured parameter of the unloaded hollow section with the opened part, the existence of a clamping event can be terminated upon a determined deviation from the ideal value.

It is important that the ideal value of the measured parameter in an unloaded state of the hollow section is regularly saved anew, in order to provide an adaptation of the system to changing, external effects.

Through such a regular measurement of the measured parameter in an unloaded state, a leak can be detected, since, upon escape of the medium, the value of the measured parameter changes drastically. Therefore, a reliable function of the clamping protection is also enabled over a long-time frame.

### BRIEF DESCRIPTION OF THE DRAWINGS

FIG. 1 is an arrangement of a clamping protection device on a side window of a motor vehicle;

FIG. 2 is a section through a frame with a sealing section according to FIG. 1;

FIG. 3 is a cross-section of a hollow section; and

FIG. 4 is a hollow section with a measuring device.

### DETAILED DESCRIPTION OF THE PREFERRED EMBODIMENTS

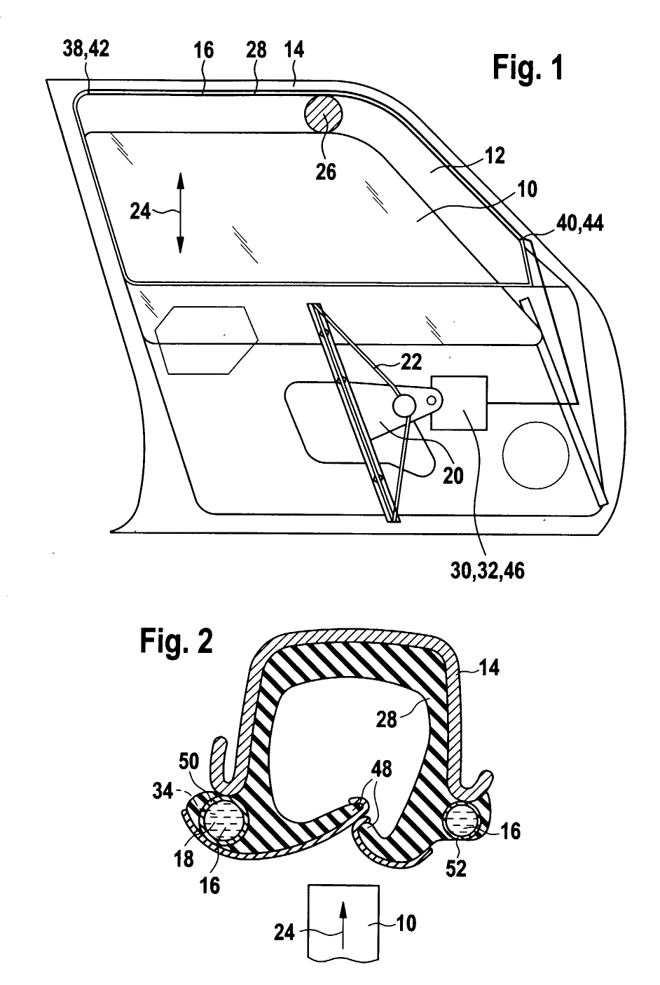

In FIG. 1, a side window of a motor vehicle is illustrated, whereby hollow section 16 with a defined cross-section 18 is disposed between a frame 14 surrounding a window opening 12 and a window pane as a moveable part 10. The pane 10 can be moved up and down by means of a motor 20 via a cable line 22 along the movement direction 24. In order to promptly recognize the clamping or squeezing of an object 26, the hollow section 16 is adhered or fused to a seal 28 arranged in the frame 14 and connected to a measuring device 30, which, for example, is a component of a control unit 32 of the motor drive 20. The hollow section 16 is filled with a conductive medium 34, for example, a saline solution and sealingly closed, such that the medium 34, upon exertion of an external force 36 on the hollow profile, cannot escape. On both ends 38, 40 of the hollow section 16, electrodes 42, 44 are disposed, which are immersed in the medium 34 and lead to a transistor switch 46 of the measuring device 30. The measuring device 30 determined in this manner the conductivity of the medium 34 over the entire length of the hollow section 16.

If the window pane 10 finds an object 26 in the window opening 12 when closing, the cross-section of the hollow section 16 deforms, whereby the measured value of the conductivity in the hollow profile 16 decreases. The timely change of this measured value is used for the initiation of a clamping protection function, in which, as a threshold value, a determined increase or decrease of the measured value per time interval is provided, which corresponds to a tolerable increase of the force on the hollow section 16. If the threshold value is exceeded or is not reached, the control unit 22 provides an order to stop or reverse the motor 20. With this measuring process, changes over a long time period of the measured value are not considered for the initiation of the clamping protection.

In an alternative embodiment, the absolute value of the measured value is continually compared with a provided desired value, which is saved previously with an opened pane in an unloaded state of the hollow section 16. In order to adapt the system to changing external conditions, the desired value is again saved anew in adjustable intervals, for example, with an opened pane 10. If a provided deviation from the desired value upon an opened state of the pane 10 is measured, or if regularly spaced ideal value falls below a provided value, the control unit 32 recognizes a leak in the hollow profile 16 and indicates that the clamping protection function is not operational.

FIG. 2 shows a section through the frame 14 of a side pane 10 with a seal 28 connected in the frame 14. For sealing of the window pane in its upper resting position, the seal 28 has two flexible sealing lips 48. Within the seal 28, two hollow sections 16 are arranged, which, for example, are molded through extrusion as one piece with the seal 28. In this manner, the material of the sealing lips 48 also simultaneously forms the wall 50 of the hollow section 16. Alternatively, the hollow section 16 can be made also as a separate hose 54, which is connected within the seal 28, or can be formed by means of a two-phase extrusion process in one machining process with the seal 28, however from a different material. This material of the wall of the hollow section, which differs from the rubber seal 28, is, for example, particularly resistant compared to the medium 34 disposed in the hollow section 16, in order to prevent a leak. The hollow section 16 with a provided, defined cross-section 18 braces itself on a side directly against the frame 14; on the other side (the side facing the pane 10), the hollow section has a thin wall that is slightly deformably in the radial direction. If the window pane 10 is closed in an undisturbed state, the cross-section 18 of the hollow section 16 does not change. However, if an object 26 that is located between the window pane 10 and the seal 28 presses on the hollow section 16, the cross-section 18 of the hollow section 16 deforms, which results in a change of the measured parameter of the medium 34 located in the hollow section 16. Therefore, it is necessary that the hollow section 16 cannot be displaced in the closing direction 24 of the pane 10, rather that the hollow section 16 immediately deforms upon the action of an external force 36. In a further variation, the walls 50 or the seal 28 surrounding the walls 50 are reinforced with plies of fabric, in order to achieve a high rigidity in the tangential direction of the hollow section 16.

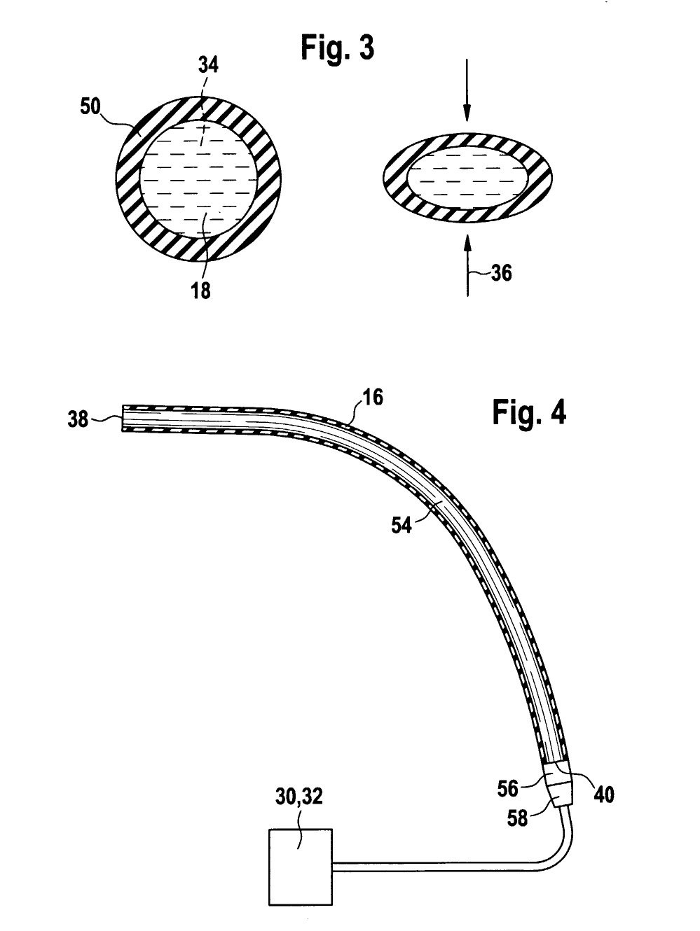

In FIG. 3, the cross-section 18 of the hollow section 16 in an unloaded state is represented on the left side. If this cross-section 18 in the loaded state is circular, it is assured that the cross-section 18 upon the action of an external force 36 on the flexible wall 50 of the hollow section 16 will be reduced. This has the results of a reliable, significant change of the measured parameter of the medium 34 in the hollow section 16, whereby specifically the clamping or squeezing of an object 26 can be detected.

In an alternative embodiment, a medium 34 with a high viscosity is found in the hollow section 16, whose pressure is measured with the measuring device 30. In this connection, the hollow section 16 is formed in FIG. 4 as a separate pressure hose 54, which is disposed on a seal 28 or is integrated with the seal. At a lower end 40, this hollow section 16 has a pressure sensor 56, which is sealingly connected with the hollow section 16. The pressure sensor 56 includes, for example, a piezzo element 58 as a pressure converter, which converts the measured pressure change into an electric signal and leads to the control unit 30. The measuring method for recognition of a clamping event is analogous to the embodiment with a medium 34, whose conductivity is measured. Also, simultaneously, the conductivity and the pressure of the medium 34 of additional measured parameters can be supplied to the control unit 30 for determining a clamping or squeezing event. The high viscosity of the medium 34 prevents the escape of the medium 34, in the event of fine tears in the walls 50 of the hollow section 16 over time. The medium 34 is generally incompressible, so that also minimal pressure differences by means of the deformation of the hollow section 16 can be detected.

In a further variation, the hollow section 16 can also be filled with a medium 34 in a gas form, in particular, with the measurement of the pressure as the measured parameter.

It will be understood that each of the elements described above, or two or more together, may also find a useful application in other types of constructions differing from the types described above.

While the invention has been illustrated and described herein as a device for opening a closing a moveable part with a seal having a hollow section, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for opening and closing a motor-driven, moveable part (10) on a motor vehicle, comprising:
a seal (28) disposed along a frame (14) of the part (10);
a control unit (30);
a clamping protection device, wherein said clamping protection device recognizes an obstacle in a displacement path of the part (10) upon closing of the part (10) and relays a signal to the control unit (30) in order to stop or reverse movement of the part (10);
wherein the seal (28) has at least one closed hollow section (16) with a defined cross-section (18), wherein said at least one hollow section (16) is filled with a medium (34) in the form of a liquid or gas, wherein said at least one hollow section (16) is provided with a measuring device (30), wherein at least one measured parameter of the medium (34) is measurable by said measuring device (30) in dependence on a change in the cross-section (18) of said at least one hollow section (16).

2. The device as defined in claim 1, wherein the cross-section (18) of the hollow section (16) is substantially circular in an unloaded state.

3. The device as defined in claim 1, wherein the at least one hollow section (16) is formed as one piece with the seal (18) in an extrusion process.

4. The device as defined in claim 1, wherein the at least one hollow section (16) is formed as a separate hose (54), wherein said hose (54) is attached along the seal (28).

5. The device as defined in claim 1, wherein the at least one hollow section (16) has an inner surface that is resistant to said medium (34).

6. The device as defined in claim 1, wherein the at least one hollow section (16) is slightly deformable in a radial direction, and wherein said at least one hollow section (16) has a thinner wall (50) than the seal (28) on a side facing toward the part (10).

7. The device as defined in claim 1, wherein a side of the at least one hollow section that faces away from the part (10) braces non-elastically against the frame (14).

8. The device as defined in claim 1, wherein the medium (34) is substantially incompressible.

9. The device as defined in claim 1, wherein the medium (34) is conductive.

10. The device as defined in claim 1, wherein the medium (34) is a conductive saline solution.

11. The device as defined in claim 1, wherein the medium (34) has a high viscosity.

12. The device as defined in claim 1, wherein one of said at least one measured parameter is a pressure of the medium (34) in the at least one hollow section (16), wherein said pressure acts on a pressure sensor (56).

13. The device as defined in claim 12, wherein said pressure sensor (56) includes a piezzo element.

14. The device as defined in claim 1, wherein one of the at least one measuring parameter is a conductivity of the medium (34) over the length of the hollow section (16), wherein the medium (34) lies as a resistance within a transistor switch (46).

15. Method for operating a device for opening and closing of a motorized, moveable part (10), comprising the following steps:
providing said moveable part (10) with a seal arranged along a frame (14) of the part (10);
providing a control unit (30);
providing a clamping protection device, wherein upon closing of the part (10), said clamping protection device detects an obstacle (25) disposed in a movement path of the part (10) and relays a signal to the control unit (30) in order to stop or reverse movement of the part (10);
wherein the seal (28) has at least one closed hollow section (16) with a defined cross-section (18), wherein said at least one hollow section (16) is filled with a medium (34) in the form of a liquid or gas;
providing a measuring device (30), wherein said measuring device (30) measures the temporal change of at least one measured parameter of the medium, and wherein a predetermined change per unit time of the at least one measured parameter is determined as a threshold value for the initiation of a clamping protection function, wherein said predetermined changed corresponds to a maximal increase of a clamping force (36).
